(19) United States
(12) Patent Application Publication
(10) Pub. No.: US 2025/0207599 A1
(43) Pub. Date: Jun. 26, 2025

(54) VACUUM PUMP

(71) Applicant: Edwards Japan Limited, Yachiyo-shi, Chiba (JP)

(72) Inventors: Haruki Suzuki, Yachiyo-shi, Chiba (JP); Wataru Yatabe, Yachiyo-shi, Chiba (JP)

(21) Appl. No.: 18/850,924

(22) PCT Filed: Apr. 10, 2023
(86) PCT No.: PCT/JP2023/014496

§ 371 Date: Sep. 25, 2024

(30) Foreign Application Priority Data
Apr. 15, 2022 (JP) 2022-067889
Mar. 29, 2023 (JP) 2023-054429

(51) Int. Cl. F04D 19/04; F04D 25/06; F04D 29/52

(52) U.S. Cl. CPC F04D 19/042; F04D 25/06; F04D 29/522

(57) ABSTRACT

A vacuum pump which can sufficiently prevent flow-in of a gas into an accommodating portion of an electric component portion which makes a rotating shaft rotatable is provided. The vacuum pump includes a casing, a rotating shaft enclosed in the casing and rotatably supported, the accommodating portion accommodating the electric component portion making the rotating shaft rotatable, a rotor disposed on an outer side of the accommodating portion and constituted integrally with the rotating shaft, a partition portion disposed on an outer peripheral side of the rotor and constituting a part of a stator, and a rotor disc extended in a radial direction from an outer peripheral surface of the rotor. An exhausted gas flows on the outer side of the rotor by rotation of the rotor. At least a part of opposed surfaces of the rotor disc and the partition portion opposed in an axial direction constitutes a non-contact seal structure which prevents the flow-in of the gas into the accommodating portion.

This application is a national stage entry under 35 U.S.C. § 371 of International Application No. PCT/JP2023/014496, filed Apr. 10, 2023, which claims the benefit of JP Application No. 2022-067889, filed Apr. 15, 2022 and JP Application No. 2023-054429, filed Mar. 29, 2023, the entire contents of each of which are incorporated herein by reference.

### TECHNICAL FIELD

The present disclosure relates to a vacuum pump which vacuum-exhausts an inside of a chamber to be exhausted.

### BACKGROUND

In manufacturing devices for a semiconductor, a liquid crystal, a solar cell, an LED (Light Emitting Diode) and the like (hereinafter, referred to as “semiconductors and the like”), a process gas is made to flow into a vacuum chamber so as to form a thin film on an object to be processed such as a wafer or the like placed in the vacuum chamber or to perform etching treatment or the like. At this time, a vacuum pump is used to vacuum-exhaust the inside of the vacuum chamber.

A turbo-molecular pump, which is one type of the vacuum pump, for example, exhausts the process gas sucked through an inlet port from an outlet port by mutual actions between rotor blades provided on an outer peripheral surface of a rotor which rotates at a high speed and stator blades disposed alternately in an axis direction of a rotating shaft of the rotor.

### SUMMARY OF THE INVENTION

In a vacuum pump, there is a concern that a part of the gas sucked through the inlet port is not exhausted from the outlet port but flows into a side of an accommodating portion which accommodates electric components portion such as a magnetic bearing which supports the rotating shaft of the rotor, a motor which rotates/drives the rotating shaft and the like, and intrudes into the accommodating portion. If the gas intrudes into the accommodating portion, it causes nonconformities, e.g., the electric components inside the accommodating portion are eroded or reaction products deposit in the accommodating portion, which would pose a trouble in a function of the vacuum pump.

As a measure against this, a vacuum pump including a shielding portion which suppresses contact between the gas and the accommodating portion is disclosed in PTL 1, for example. The shielding portion is constituted by a substantially annular-shaped member. The shielding portion has an upper end surface opposed to a bottom surface of a rotor cylindrical portion and is disposed so that an interval therebetween becomes a micro width. As a result, contact between the accommodating portion disposed on the inside of the rotor cylindrical portion and the gas is suppressed.

However, in the vacuum pump including the shielding portion, lengths in a radial direction of the upper end surfacer of the opposed shielding portion and the bottom surface of the rotor cylindrical portion are short, and there is a concern that flow-in of the gas into the accommodating portion cannot be prevented sufficiently.

The present disclosure has been made in view of the aforementioned circumstances and has an object to provide a vacuum pump which can sufficiently prevent the flow-in of the gas into the accommodating portion of the electric component portion which makes the rotating shaft rotatable.

In order to achieve the aforementioned object, the vacuum pump of the present disclosure includes:
a casing;
a rotating shaft enclosed in the casing and rotatably supported;
an accommodating portion accommodating an electric component portion making the rotating shaft rotatable;
a rotor disposed on an outer side of the accommodating portion and constituted integrally with the rotating shaft,
a stator disposed on an outer peripheral side of the rotor; and
a rotor disc portion extended in a radial direction from an outer peripheral surface of the rotor,
with an exhausted gas being flowing outside of the rotor by rotation of the rotor, wherein
at least a part of opposed surfaces, opposed in an axial direction of the rotor disc portion and the stator, constitutes a non-contact seal structure which prevents flow-in of the gas into the accommodating portion.

In the aforementioned vacuum pump,
at least one of the opposed surfaces of the rotor disc portion and the stator may be formed as an inclined surface.

In the aforementioned vacuum pump,
the opposed surfaces of the rotor disc portion and the stator may be formed as inclined surfaces, and inclination angles of the inclined surfaces may be the same.

In the aforementioned vacuum pump, it may be so configured that
the stator further includes a stator disc portion opposed to an upstream side of the gas of the rotor disc portion in the axial direction;
a first spiral groove for constituting an exhaust mechanism is provided on at least one of opposed surfaces to the rotor disc portion and the stator disc portion; and
the non-contact seal structure is constituted by opposed surfaces opposed in the axial direction of a rear surface, which is a downstream side of the gas of the rotor disc portion, and the stator.

In the aforementioned vacuum pump,
the rotor disc portion may constitute a lowest stage of the exhaust mechanism.

In the aforementioned vacuum pump,
a rectifying portion having an opposed surface opposed in the axial direction of a rear surface, which is the downstream side of the gas of the rotor disc portion, may be further included.

In the aforementioned vacuum pump,
the rectifying portion may be configured to be a spiral groove portion, which has a disc shape and has a second spiral groove provided on an opposed surface of the rotor disc portion.

In the aforementioned vacuum pump, it may be so configured that
a cylinder portion constituted integrally with the rotor disc portion and having an outer peripheral surface opposed to an inner peripheral surface of the spiral groove portion is provided;
a thread groove provided on at least either one of the inner peripheral surface of the spiral groove portion and the outer peripheral surface of the cylinder portion is provided; and
the non-contact seal structure is constituted by the opposed surfaces opposed in the axial direction of a surface, which is a downstream side of the gas of the cylinder portion, and the stator.

In the aforementioned vacuum pump, it may be so configured that
the stator includes a channel defining portion which is heated by heating means and defines the gas channel; and
the non-contact seal structure is constituted by an opposed surface opposed in the axial direction of the rotor disc portion and the channel defining portion.

According to the present disclosure, the vacuum pump which can sufficiently prevent flow-in of the gas into the accommodating portion of the electric component portion which makes the rotating shaft rotatable can be provided.

### BRIEF DESCRIPTION OF DRAWINGS

FIG. 1(A) is a vertical sectional view illustrating a constitution of a vacuum pump according to a first example of the present disclosure, and FIG. 1(B) is an enlarged view of a C part in FIG. 1(A).

FIG. 2 is an explanatory diagram illustrating a schematic constitution of a stator disc provided in the vacuum pump on a D-D line in FIG. 1(A).

FIG. 3 is a circuit diagram of an amplification circuit provided in the vacuum pump according to the first example of the present disclosure.

FIG. 4 is a time chart illustrating control when a current instructed value is larger than a detection value in the vacuum pump according to the first example of the present disclosure.

FIG. 5 is a time chart illustrating control when the current instructed value is smaller than the detection value in the vacuum pump according to the first example of the present disclosure.

FIG. 6(A) is a vertical sectional view illustrating a constitution of a vacuum pump according to a second example of the present disclosure, and FIG. 6(B) is an enlarged view of an E part in FIG. 6(A).

FIG. 7 is a partially enlarged view of a vertical sectional view illustrating a configuration of a vacuum pump according to a third example of the present disclosure.

FIG. 8 is a partially enlarged view of a vertical sectional view illustrating a configuration of a vacuum pump according to a fourth example of the present disclosure.

FIG. 9 is a partially enlarged view of a vertical sectional view illustrating a configuration of a vacuum pump according to a fifth example of the present disclosure.

### DETAILED DESCRIPTION

A vacuum pump according to examples of the present disclosure will be described by referring to the following drawings.

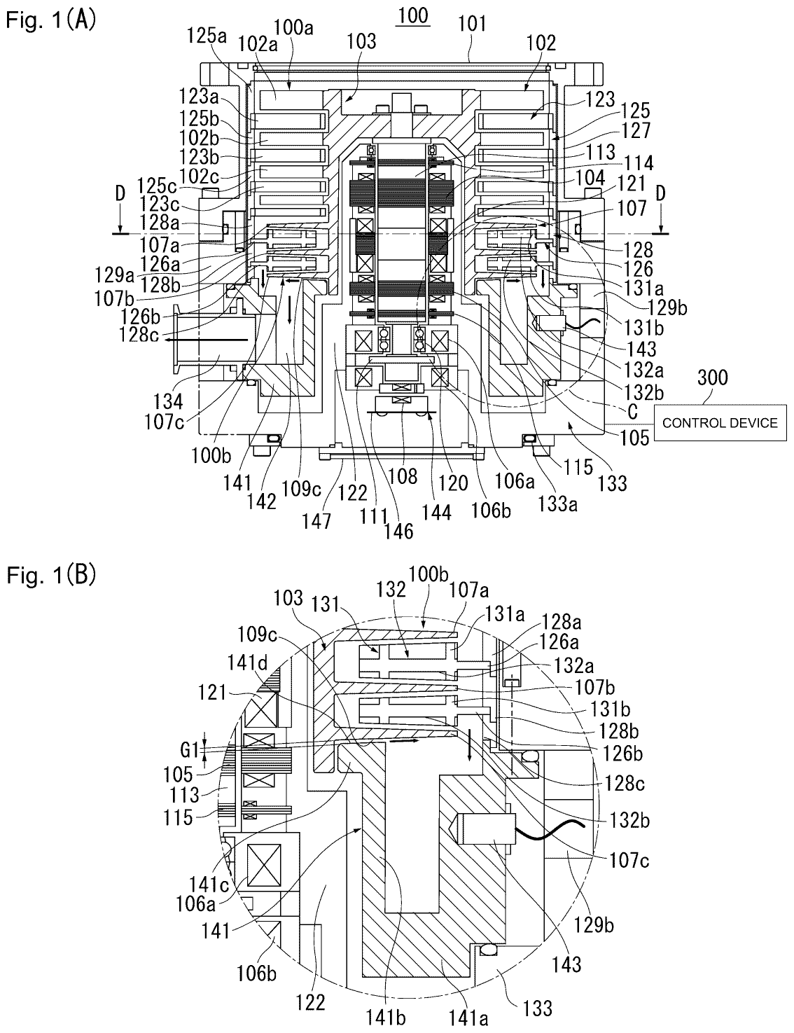

The vacuum pump according to a first example will be described by referring to FIG. 1. The vacuum pump 100 is a complex-type vacuum pump including a turbo-molecular pump portion 100a on an upstream side of a flowing-in gas and a Siegbahn-type pump portion 100b on a downstream side as shown in FIG. 1(A).

In this vacuum pump 100 an inlet port 101 is formed on an upper end of a cylindrical outer cylinder 127. And inward of the outer cylinder 127, a rotor 103 is provided. On a peripheral part of this rotor 103, a plurality of rotor blades 102 (102a, 102b, 102c, . . . ), which are turbine blades for sucking/exhausting a gas, and a plurality of rotor discs 107 (107a, 107b, 107c) are formed radially and in plural stages and are extended in a radial direction. The rotor blade 102 constitutes a part of the turbo-molecular pump portion 100a, and the rotor disc 107 constitutes a part of the Siegbahn-type pump portion 100b. The rotor blades 102 are disposed on the upstream side of the rotor 103, and the rotor discs 107 are disposed on the downstream side of the rotor blade 102 on the lowest stage.

At a center of the rotor 103, a rotating shaft 113 is mounted, and the rotating shaft 113 and the rotor 103 are integrally constituted. This rotating shaft 113 is rotatably supported and is floated/supported in the air and position-controlled by a magnetic bearing of five-axis control, for example. The rotor 103 is constituted by metal such as aluminum or an aluminum alloy in general.

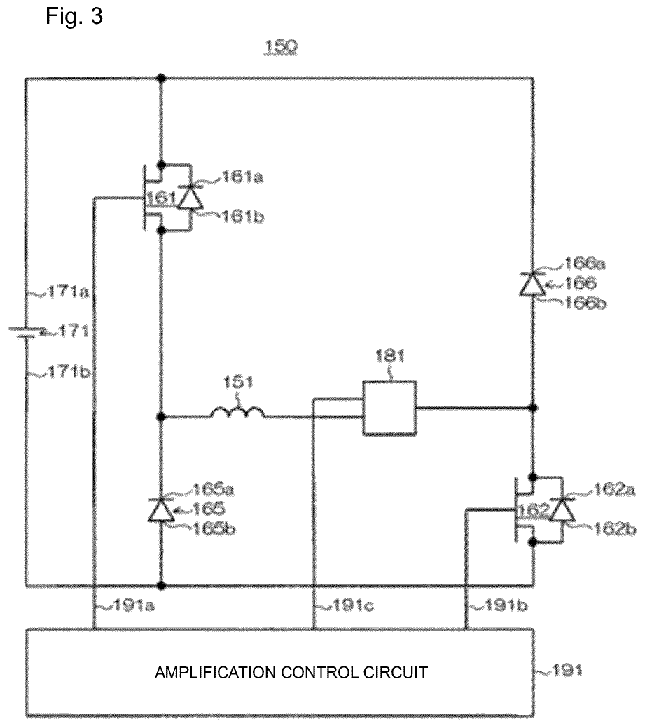

Regarding upper-side radial electromagnets 104, four electromagnets are disposed in pairs on an X-axis and a Y-axis. Close to the upper-side radial electromagnets 104 and corresponding to each of the upper-side radial electromagnets 104, four upper-side radial sensors 114 are provided. For the upper-side radial sensor 114, an inductance sensor or an eddy current sensor having a conductive winding or the like is used, for example, and a position of the rotating shaft 113 is detected on the basis of a change in inductance of this conductive winding changing in accordance with the position of the rotating shaft 113. The upper-side radial sensor 114 is configured to detect radial displacement of the rotating shaft 113, that is, of the rotor 103 fixed thereto and to send it to a control device 300. In this control device 300, a compensation circuit having a PID adjustment function, for example, generates an excitation control instruction signal of the upper-side radial electromagnet 104 on the basis of a position signal detected by the upper-side radial sensor 114, and an amplification circuit 150 (which will be described later) shown in FIG. 3 excites/controls the upper-side radial electromagnet 104 on the basis of this excitation control instruction signal so that a radial position on an upper side of the rotating shaft 113 is adjusted.

And this rotating shaft 113 is formed of a material with high magnetic permeability (iron, stainless or the like) or the like and is configured to be attracted by a magnetic force of the upper-side radial electromagnet 104. Such adjustment is made independently in an X-axis direction and in a Y-axis direction, respectively. Moreover, a lower-side radial electromagnet 105 and a lower-side radial sensor 115 are disposed similarly to the upper-side radial electromagnet 104 and the upper-side radial sensor 114, and a radial position on a lower side of the rotating shaft 113 is adjusted similarly to the radial position on the upper side.

Moreover, axial electromagnets 106a and 106b are disposed by vertically sandwiching a disc-shaped metal disc 111 provided on a lower part of the rotating shaft 113. The metal disc 111 is constituted by a material with high magnetic permeability such as iron. An axial sensor 108 is provided in order to detect axial displacement of the rotating shaft 113, and it is configured such that an axial position signal thereof is sent to the control device 300.

And in the control device 300, the compensation circuit having the PID adjustment function, for example, generates the excitation control instruction signal for each of the axial electromagnet 106a and the axial electromagnet 106b on the basis of an axial position signal detected by the axial sensor 108, and the amplification circuit 150 excites/controls the axial electromagnet 106a and the axial electromagnet 106b on the basis of these excitation control instruction signals, respectively, so that the axial electromagnet 106a attracts the metal disc 111 upward by the magnetic force, while the axial electromagnet 106b attracts the metal disc 111 downward, and the axial position of the rotating shaft 113 is adjusted.

As described above, the control device 300 appropriately adjusts the magnetic force by the axial electromagnets 106a and 106b applied to the metal disc 111, magnetically floats the rotating shaft 113 in the axial direction and holds it in a space in a non-contact manner. Note that the amplification circuit 150 which excites/controls the upper-side radial electromagnet 104, the lower-side radial electromagnet 105, and the axial electromagnets 106a and 106b will be described later.

On the other hand, a motor 121 includes a plurality of magnetic poles disposed in a circumferential state so as to surround the rotating shaft 113. Each of the magnetic poles is controlled by the control device 300 so as to rotate/drive the rotating shaft 113 through an electromagnetic force acting between it and the rotating shaft 113. Moreover, the motor 121 incorporates rotational speed sensors such as a Hall element, a resolver, an encoder and the like, not shown, for example, and it is configured such that a rotational speed of the rotating shaft 113 is detected by a detection signal of this rotational speed sensor.

Furthermore, in the vicinity of a lower-side radial sensor 115, for example, a phase sensor, not shown, is mounted so as to detect a phase of rotation of the rotating shaft 113. The control device 300 is configured to detect a position of the magnetic pole by using detection signals of both this phase sensor and the rotational speed sensor.

With a slight clearance from the rotor blades 102 (102a, 102b, 102c, . . . ), a plurality of stator blades 123 (123a, 123b, 123c, . . . ) are disposed. The turbo-molecular pump portion 100a is constituted by the rotor blades 102 and the stator blades 123. Each of the rotor blades 102 (102a, 102b, 102c, . . . ) is formed with inclination by a predetermined angle from a plane perpendicular to an axis of the rotating shaft 113 so as to transfer molecules of an exhaust gas to a lower direction by a collision, respectively. The stator blades 123 (123a, 123b, 123c, . . . ) are constituted by metal such as aluminum, iron, stainless, copper and the like or an alloy containing these metals as components, for example.

Moreover, the stator blades 123 are also formed similarly with inclination by a predetermined angle from the plane perpendicular to the axis of the rotating shaft 113 and are disposed alternately with stages of the rotor blades 102 toward an inside of the outer cylinder 127. And outer peripheral ends of the stator blades 123 are supported in a state fitted and inserted between stator-blade spacers 125 (125a, 125b, 125c, . . . ) stacked in plural stages.

On the other hand, with a slight clearance from the rotor discs 107 (107a, 107b, 107c), a plurality of stator discs 126 (126a, 126b) are disposed. The Siegbahn-type pump portion 100b is constituted by the rotor discs 107 and the stator discs 126. The stator blades 123 and the stator discs 126 constitute a part of the stator.

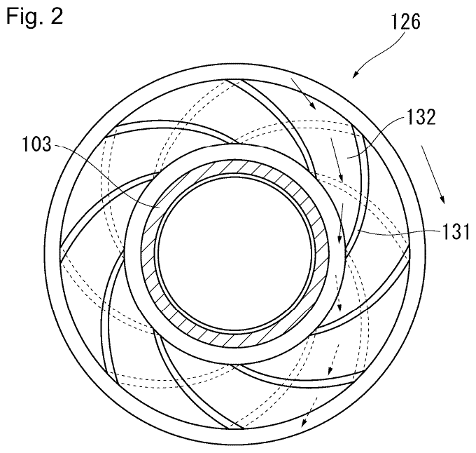

The rotor discs 107 (107a, 107b, 107c) are formed perpendicularly to the axis of the rotating shaft 113 and is formed in a tapered shape in which a section in the radial direction becomes thinner toward a peripheral edge part. A lower side surface 109c of the rotor disc 107c on the lowest stage will be described later. On both surfaces on an upstream side and a downstream side of the gas of the stator discs 126 (126a, 126b), a plurality of ridge portions 131 (131a, 131b) and a plurality of root portions 132 (132a, 132b) are formed, and a plurality of spiral grooves (corresponding to first spiral groove portions) are formed by the plurality of ridge portions 131 (131a, 131b) and the plurality of root portions 132 (132a, 132b) as shown in FIG. 2. Note that the spiral groove for constituting an exhaust mechanism is provided on at least either one of the opposed surfaces of the rotor disc 107 and the stator disc 126.

Moreover, the stator discs 126 (126a, 126b) are formed perpendicularly to the axis of the rotating shaft 113 and are disposed alternately with the stages of the rotor discs 107 inward of exterior components 129a. And outer peripheral ends of the stator discs 126 (126a, 126b) are supported in a state fitted/inserted between a plurality of stacked stator disc spacers 128 (128a, 128b, 128c). Heights in the axial direction of the stator disc spacers 128 (128a, 128b, 128c) are set to become lower toward the downstream side of the gas. As a result, a capacity of the channel is gradually decreased toward the downstream side of the gas so as to compress the gas.

The Siegbahn-type pump portion 100b gives a motion amount in a tangent direction by the rotor disc 107 to gas molecules diffused and entering in the channel of the spiral groove provided in the stator disc 126 and can perform exhaustion by giving a predominant directivity toward the exhaust direction by the channel of the spiral groove.

Each of the stator-blade spacer 125 and stator disc spacer 128 is a ring-shaped member and is constituted by metal such as aluminum, iron, stainless, copper or the like or an alloy containing these metals as components, for example. On the outer periphery of the stator blade spacer 125, the outer cylinder 127 is fixed with a slight clearance, and on the outer periphery of the stator disc spacer 128, the exterior component 129a is fixed with a slight clearance. The outer cylinder 127, the exterior component 129a, and the exterior component 129b are disposed in the order from the upstream side of the gas and constitute a casing of the vacuum pump 100. In this casing, the rotating shaft 113 is enclosed. On the bottom part of the casing, a base portion 133 is disposed. An outlet port 134 is formed in the exterior component 129b, which communicates to the outside. The exhaust gas which has entered from the chamber (vacuum chamber) side, which is a chamber to be exhausted, into the inlet port 101 and has been transferred to the base portion 133 side is sent to the outlet port 134.

The base portion 133 is a disc-shaped member constituting a bottom portion of the vacuum pump 100 and is constituted by metal such as iron, aluminum, stainless or the like in general. The base portion 133 physically holds the vacuum pump 100 and has a function of a conducting path of a heat at the same time and thus, metal with rigidity and high heat conductivity such as iron, aluminum, copper or the like is preferably used. Moreover, on the base portion 133, a water-cooling pipe 133a for cooling the electric components such as the motor 121 and the like is provided.

Moreover, in order to prevent intrusion of the gas having been sucked through the inlet port 101 into the electric component portion constituted by the upper-side radial electromagnet 104, the upper-side radial sensor 114, the motor 121, the lower-side radial electromagnet 105, the lower-side radial sensor 115, the axial electromagnets 106a, 106b, the axial sensor 108 and the like and making the rotating shaft 113 rotatable, the electric component portion is covered by the accommodating portion 122. That is, the electric component portion is accommodated in the accommodating portion 122. The inside of this accommodating portion 122 is kept at a predetermined pressure by a purge gas in some cases.

In this case, a pipeline, not shown, is disposed in the base portion 133, and the purge gas is introduced through this pipeline. The introduced purge gas is sent out to the outlet port 134 through clearances between a protective bearing 120 and the rotating shaft 113, between the rotor of the motor 121 and the stator, and between the accommodating portion 122 and an inner-peripheral side cylinder portion of the rotor blade 102.

Here, the vacuum pump 100 may control based on specification of a model and individually adjusted specific parameters (characteristics corresponding to the model, for example). In order to store the control parameters, the vacuum pump 100 includes an electronic circuit portion 144 in a main body thereof. The electronic circuit portion 144 is constituted by electronic components such as a semiconductor memory including an EEP-ROM and the like and a semiconductor element and the like for access, a substrate 146 for mounting them and the like. This electronic circuit portion 144 is accommodated in a lower part of a rotational speed sensor, not shown, close to a center, for example, of the base portion 133 constituting the lower part of the vacuum pump 100 and is closed by an airtight bottom lid 147.

Subsequently, regarding the vacuum pump 100 constituted as above, the amplification circuit 150 which excites/controls the upper-side radial electromagnet 104, the lower-side radial electromagnet 105, and the axial electromagnets 106a, 106b will be described by using FIG. 3.

In FIG. 2, an electromagnet winding 151 constituting the upper-side radial electromagnet 104 and the like has one end thereof connected to a positive electrode 171a of a power source 171 through a transistor 161 and has the other end connected to a negative electrode 171b of the power source 171 through a current detection circuit 181 and a transistor 162. And the transistors 161 and 162 are so-called power MOSFET and have a structure in which a diode is connected between a source and a drain thereof.

At this time, the transistor 161 has a cathode terminal 161a of the diode thereof connected to the positive electrode 171a and has an anode terminal 161b connected to one end of the electromagnet winding 151. Moreover, the transistor 162 has a cathode terminal 162a of the diode thereof connected to the current detection circuit 181 and has an anode terminal 162b connected to the negative electrode 171b.

On the other hand, a diode 165 for current regeneration has a cathode terminal 165a thereof connected to one end of the electromagnet winding 151 and has an anode terminal 165b thereof connected to the negative electrode 171b. Moreover, similarly to this, a diode 166 for current regeneration has a cathode terminal 166a thereof connected to the positive electrode 171a and an anode terminal 166b thereof connected to the other end of the electromagnet winding 151 through the current detection circuit 181. And the current detection circuit 181 is constituted by a Hall-sensor type current sensor or an electric resistance element, for example.

The amplification circuit 150 constituted as above corresponds to one electromagnet. Thus, in a case where the magnetic bearing is five-axis control and has 10 pieces of the electromagnets 104, 105, 106a and 106b in total, the similar amplification circuit 150 is constituted for each of the electromagnets, and 10 units of the amplification circuits 150 are connected in parallel to the power source 171.

Moreover, an amplification control circuit 191 is constituted by a digital signal processor portion (hereinafter, referred to as a DSP portion), not shown, of the control device 300, for example, and this amplification control circuit 191 is configured to switch on/off the transistors 161 and 162.

The amplification control circuit 191 is configured to compare a current value (a signal reflecting this current value is referred to as a current detection signal 191c) detected by the current detection circuit 181 and a predetermined current instructed value. And on the basis of this comparison result, a size of a pulse width (pulse-width time Tp1, Tp2) to be generated in a control cycle Ts, which is one cycle by PWM control, is determined. As a result, gate drive signals 191a and 191b having this pulse width are configured to be output to gate terminals of the transistors 161 and 162 from the amplification control circuit 191.

Position control of the rotor 103 may execute at a high speed and with a strong force when passing a resonant point during an acceleration operation of a rotational speed of the rotor 103 at occurrence of a disturbance during a constant-speed operation and the like. Thus, a high voltage such as approximately 50V, for example, is used in the power source 171 so that the current flowing through the electromagnet winding 151 can be rapidly increased (or decreased). Moreover, a capacitor is usually connected between the positive electrode 171a and the negative electrode 171b of the power source 171 for stabilization of the power source 171 (not shown).

In the configuration as above, when both the transistors 161 and 162 are turned on, the current flowing through the electromagnet winding 151 (hereinafter referred to as an electromagnet current iL) increases, while when the both are turned off, the electromagnet current iL decreases.

Moreover, when one of the transistors 161 and 162 is turned on, while the other is turned off, a so-called flywheel current is held. And by causing the flywheel current to flow through the amplification circuit 150 as above, a hysteresis loss in the amplification circuit 150 is decreased, and power consumption of the circuit can be kept low. Moreover, by controlling the transistors 161 and 162 as above, a high-frequency noise such as a harmonic or the like generated in the vacuum pump 100 can be reduced. Furthermore, by measuring this flywheel current by the current detection circuit 181, the electromagnet current iL flowing through the electromagnet winding 151 can be detected.

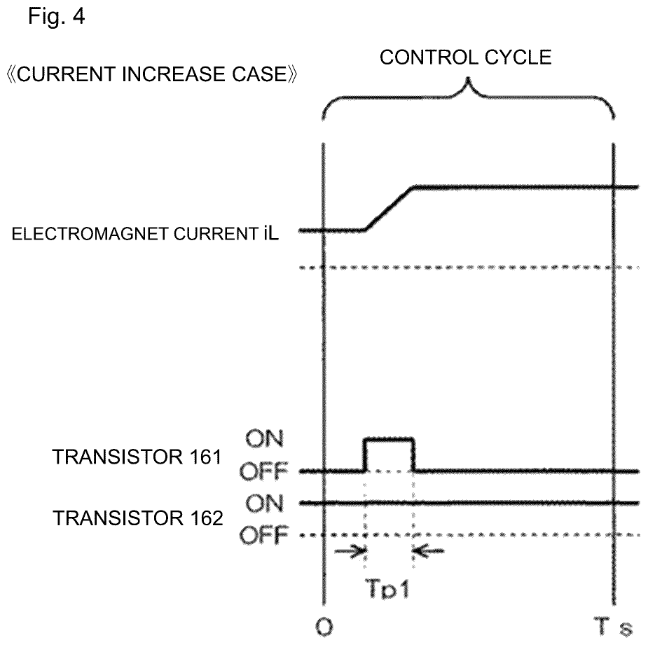

That is, if the detected current value is smaller than the current instructed value, the transistors 161 and 162 are both turned on for a period of time corresponding to the pulse-width time Tp1 once in a control cycle Ts (100 μs, for example) as shown in FIG. 4. Thus, the electromagnet current iL during this period increases toward a current value iLmax (not shown) that can be made to flow from the positive electrode 171a to the negative electrode 171b through the transistors 161 and 162.

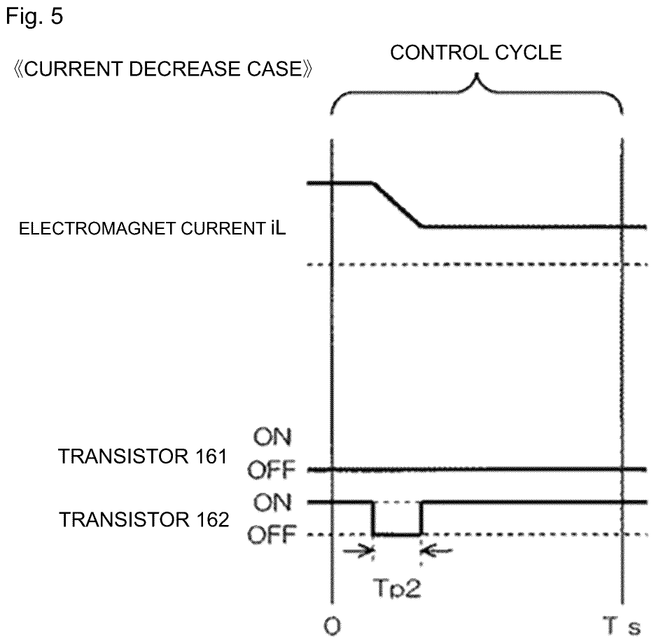

On the other hand, if the detected current value is larger than the current instructed value, the transistors 161 and 162 are both turned off for a period of time corresponding to the pulse-width time Tp2 once in the control cycle Ts as shown in FIG. 5. Thus, the electromagnet current iL during this period decreases toward a current value iLmin (not shown) that can be regenerated from the negative electrode 171b to the positive electrode 171a through the diodes 165 and 166.

And in any case, after elapse of the pulse-width time Tp1, Tp2, either one of the transistors 161 and 162 is turned on. Thus, the flywheel current is held in the amplification circuit 150 during this period.

Here, how the exhaust gas is sucked and exhausted in the vacuum pump 100 will be described. In the turbo-molecular pump portion 100a on the upstream side, when the rotor blade 102 is rotated/driven together with the rotating shaft 113 by the motor 121, by actions of the rotor blade 102 and the stator blade 123, the exhaust gas is sucked from the chamber, which is the chamber to be exhausted, through the inlet port 101. A rotational speed of the rotor blade 102 is usually 20000 rpm to 90000 rpm, and a peripheral speed at a distal end of the rotor blade 102 reaches 200 m/s to 400 m/s. The exhaust gas sucked through the inlet port 101 passes between the rotor blade 102 and the stator blade 123 on the outer side of the rotor 103 and is transferred to the Siegbahn-type pump portion 100b on the downstream side. In the Siegbahn-type pump portion 100b, by means of mutual actions between the rotor disc 107 rotated/driven similarly to the rotor blade 102 and the stator disc 126 in which the spiral groove is provided, predominant directivity toward the outlet port 134 is given to the transferred gas molecules. Then, the exhaust gas passes between the rotor disc 107 and the stator disc 126 on the outer side of the rotor 103 and is exhausted through the outlet port 134.

At this time, temperatures of the rotor blade 102 and the rotor disc 107 are raised by conduction of a friction heat generated when the exhaust gas contacts the rotor blade 102 and the rotor disc 107 or a heat generated in the motor 121, but this heat is conducted to sides of the stator blade 123 or the stator disc 126 by radiation or conduction by a gas molecule or the like of the exhaust gas.

The stator blade spacers 125 are joined to each other on the outer peripheral parts and conduct the heat received by the stator blade 123 from the rotor blade 102 or the friction heat generated when the exhaust gas contacts the stator blade 123 or the like to the outside. Moreover, the stator disc spacers 128 are also joined to each other on the outer peripheral parts and conduct the heat received by the stator disc 126 from the rotor disc 107 or the friction heat generated when the exhaust gas contacts the stator disc 126 to the outside.

Subsequently, featured portions of the vacuum pump 100 according to this example will be described. If the exhaust gas having been transferred by the Siegbahn-type pump portion 100b on the downstream side is not sent to the outlet port 134 but flows into the accommodating portion 122 accommodating the electric component portion, which makes the rotating shaft 113 rotatable, and intrudes into the accommodating portion 122, the electric components in the accommodating portion 122 might be eroded or reaction products might deposit in the accommodating portion 122, which causes a trouble in performances of the vacuum pump 100. Thus, the vacuum pump 100 of this example has a non-contact seal structure which prevents flow-in of the gas into the accommodating portion 122.

This non-contact seal structure will be described. A partition portion 141 defines a channel 142 of the gas to be exhausted. The partition portion 141 is constituted by, as shown in FIG. 1(B), a base portion 141a, a cylinder portion 141b standing from the base portion 141a, and an inward flange portion 141c extended inward in the radial direction from an upper end of the cylinder portion 141b. The partition portion 141 is disposed on outer peripheral sides of the accommodating portion 122 and the rotor 103. Note that the partition portion 141 constitutes a part of the stator. In FIG. 1, hatching is applied to the partition portion 141 and the rotor 103 in order to facilitate understanding.

A lower side surface 109c (a rear surface not opposed to the stator disc 126b on the lowest stage), which is on the downstream side of the gas, of the rotor disc (rotor disc portion) 107c on the lowest stage and an upper surface 141d of the inward flange portion 141c are opposed to each other in the axial direction. This opposed surface constitutes the non-contact seal structure which prevents the flow-in of the gas into the accommodating portion 122. Note that, the opposed surface extends over the circumference, and that the opposed surface is provided so that at least a part constitutes the non-contact seal structure. A gap G1 between the lower side surface 109c of the rotor disc 107c and the upper surface 141d of the inward flange portion 141c is a slight clearance. The gap G1 between the lower side surface 109c of the rotor disc 107c and the upper surface 141d of the inward flange portion 141c is set appropriately to approximately 1 mm to 1.5 mm, for example.

In this non-contact seal structure, by means of a drag effect by rotation of the rotor disc 107c, the gas is exhausted to directions of the channel 142 of the gas and the outlet port 134 toward the outer side in the radial direction from the gap G1 between the lower side surface 109c of the rotor disc 107c and the upper surface 141d of the inward flange portion 141c. The longer a length of a surface (corresponding to a length of the upper surface 141d) where the lower side surface 109c of the rotor disc 107c and the upper surface 141d of the inward flange portion 141c are opposed in the axial direction is, the better the exhaust performance and the seal performance by the drag effect become. The lower side surface 109c of the rotor disc 107c and the upper surface 141d of the inward flange portion 141c are formed as inclined surfaces rising toward an outer side from an inner side, inclination directions are the same, and inclination angles are also approximately the same. Thus, the length of the surface where the lower side surface 109c of the rotor disc 107c and the upper surface 141d of the inward flange portion 141c are opposed in the axial direction becomes longer than a case where the lower side surface 109c of the rotor disc 107c and the upper surface 141d of the inward flange portion 141c are both horizontal surfaces, whereby the exhaust performance is improved.

Moreover, since the higher the peripheral speed of the rotor disc 107c is, the better the exhaust performance by the drag effect by the rotor disc 107c becomes, the non-contact seal structure is preferably provided on as an outer peripheral side as possible of the rotor disc 107c. By providing the non-contact seal structure on the outer peripheral side of the rotor disc 107c, there can be an allowance for expanding the gap G1, and machining or assembling of the rotor disc 107c and the partition portion 141 is facilitated. However, a balance with a channel area of the gas may be considered. Note that a size of a clearance in a radial direction between the inward flange portion 141c of the partition portion 141 and the rotor 103 may be approximately the same as the gap G1.

In the partition portion 141, a heater 143 as a heating means is provided on the base portion 141a. Thus, the partition portion 141 also plays a role of a heater spacer. The partition portion 141 is fixed to the base portion 133, the exterior component 129b and the like through an insulating member. By the way, in the manufacturing process of a semiconductor or the like, some process gases introduced into a chamber have a characteristic that the gas becomes solid when a pressure thereof becomes higher than a predetermined value or when a temperature thereof becomes lower than a predetermined value. Inside the vacuum pump 100, the pressure of the exhaust gas is the lowest at the inlet port 101 and the highest at the outlet port 134. If the pressure of the process gas becomes higher than the predetermined value, or the temperature thereof becomes lower than the predetermined value in the middle of transfer from the inlet port 101 to the outlet port 134, the process gas becomes a solid state and adheres to and deposits on the inside of the vacuum pump 100.

For example, if SiCl4 is used as a process gas in an Al etching device, it is known from a steam-pressure curve that a solid product (AlCl3, for example) is precipitated at a low vacuum (760 [torr] to 10-2 [torr]) and at a low temperature (approximately 20 [° C.]) and adheres to/deposits on the inside the vacuum pump 100 as a result, if the precipitates of the process gas deposit inside the vacuum pump 100, the deposits narrow a pump channel and cause deterioration of performance of the vacuum pump 100. Then, there was such a state that the aforementioned products easily solidify or adhere to in a portion close to the outlet port 134 where a pressure is high.

Thus, in order to solve this problem, a heater 143 or an annular water-cooling pipe, not shown, is wound on the partition portion 141 or the like which defines the gas channel 142, and a temperature sensor (a thermistor, for example), not shown, is embedded in the partition portion 141, for example, and heating of the heater 143 or cooling by the water-cooling pipe is controlled (hereinafter, referred to as TMS. TMS: Temperature Management System) so that the temperature of the partition portion 141 is kept at a certain high temperature (set temperature) on the basis of a signal of this temperature sensor.

As described above, in this example, since the non-contract seal structure which can prevent the flow-in of the gas into the accommodating portion 122 is constituted by the opposed surfaces opposed in the axial direction of the lower side surface 109c of the rotor disc 107c on the lowest stage and the upper surface 141d of the inward flange portion 141c, the non-contact seal structure by the relatively long opposed surface can be realized. Therefore, the vacuum pump which can sufficiently prevent the flow-in of the exhaust gas into the accommodating portion 122 can be provided.

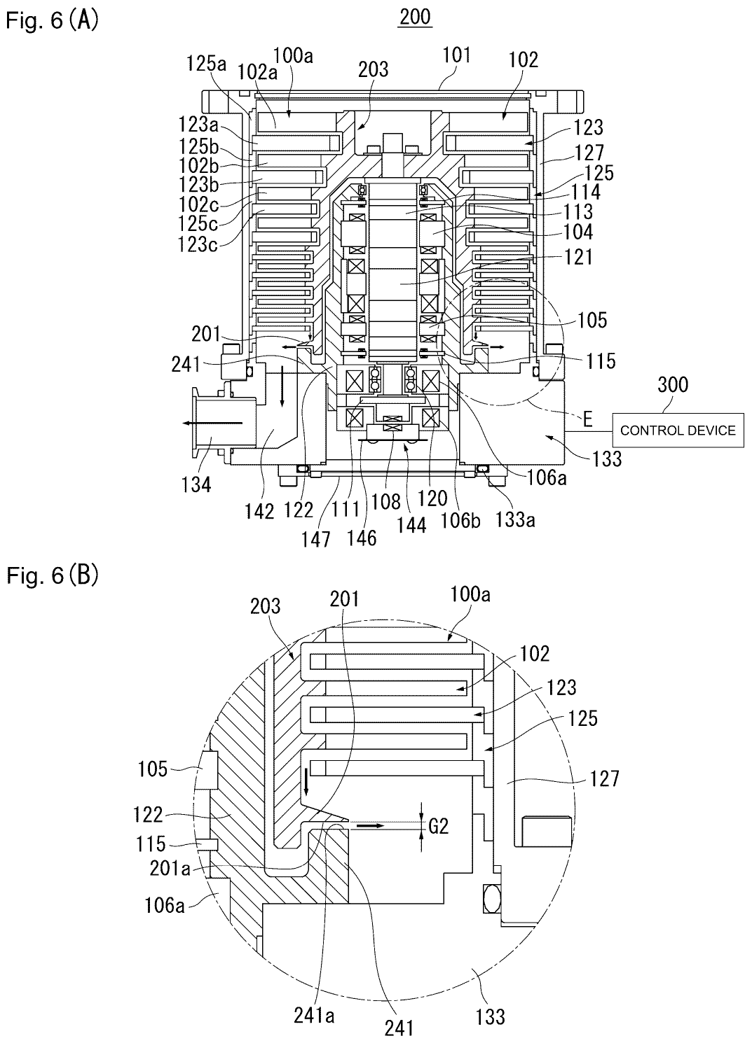

The vacuum pump according to a second example will be described by referring to FIG. 6. Note that, in the second example, the same reference numerals are given to constituent elements similar to those of the vacuum pump according to the first example so that explanation thereof is omitted, and points different from the first example will be described. The vacuum pump 200 according to the second example is, as shown in FIG. 6(A), a vacuum pump constituted by the turbo-molecular pump portion 100a. On a peripheral part of a rotor 203, a plurality of the rotor blades 102 (102a, 102b, 102c, . . . ) are formed radially and in plural stages, and a rotor disc portion 201 is extended in the radial direction to the downstream side of the rotor blade 102 on the lowest stage. The rotor disc portion 201 is formed perpendicularly to the axis of the rotating shaft 113 and has an upper side surface formed as an inclined surface, while a lower side surface 201a as a horizontal surface. The rotor disc portion 201 is not directly involved in exhaustion of the exhaust gas, unlike the rotor blade 102. Note that, in FIG. 6, the accommodating portion 122 and the rotor 203 are hatched in order to facilitate understanding.

A standing portion 241 is stood along outer peripheries of the accommodating portion 122 and the rotor 203. The standing portion 241 has a low cylindrical shape. The standing portion 241 constitutes a part of the stator. The lower side surface 201a on the downstream side of the rotor disc portion 201 and an upper surface 241a of the standing portion 241 are opposed in the axial direction as shown in FIG. 6(B). This opposed surface constitutes the non-contact seal structure which prevents the flow-in of the gas into the accommodating portion 122. Note that, though this opposed surface extends over the circumference, the opposed surface may be provided so that at least a part constitutes the non-contact seal structure. A gap G2 between the lower side surface 201a of the rotor disc portion 201 and the upper surface 241a of the standing portion 241 is a micro gap, and a size and the like of the gap G2 are similar to those of the gap G1. The lower side surface 201a of the rotor disc portion 201 and the upper surface 241a of the standing portion 241 are not inclined surfaces but horizontal surfaces.

As described above, in this example, the non-contact seal structure which prevents the flow-in of the gas into the accommodating portion 122 can be constituted also by providing the rotor disc portion 201 not directly involved in the exhaustion of the exhaust gas by being extended from the peripheral part of the rotor 203.

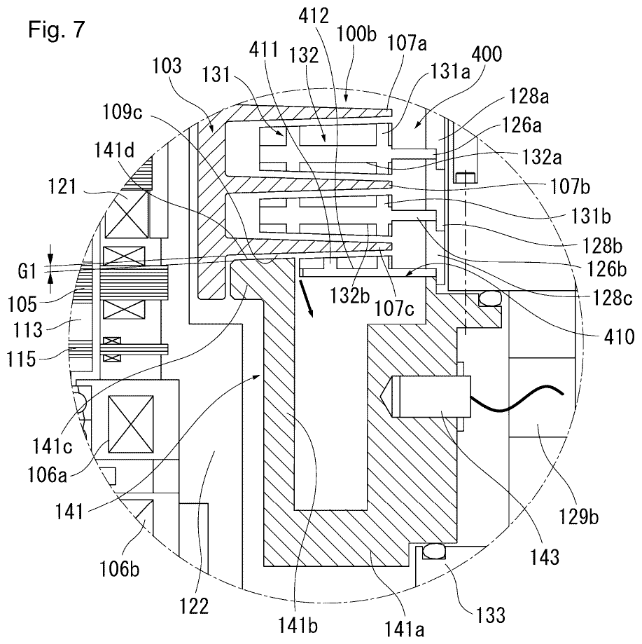

A vacuum pump according to a third example will be explained with reference to FIG. 7. Note that, in the third example, the same reference numerals are given to constituent elements similar to those according to the vacuum pump in the first example, whose explanation will be basically omitted, and points different from those in the first example will be Explained. The vacuum pump 400 according to the third example can solve the problem that the exhaust performance lowers when there is a sudden channel enlarged portion on the downstream side of the gas of the rotor disc 107c on the lowermost stage. The vacuum pump 400 has, as shown in FIG. 7, a spiral groove portion (Siegbahn portion) 410 formed in a disc shape on a rear surface side, which is the downstream side of the gas, of the rotor disc 107c on the lowermost stage. In the spiral groove portion 410, a plurality of ridge portions 411 and a plurality of root portions 412 are formed on an opposed surface of the rotor disc 107c on the upstream side of the gas and on the lowermost stage similarly to the stator disc 126, and a plurality of the spiral grooves (corresponding to the second spiral grooves) are constituted by the plurality of ridge portions 411 and the plurality of root portions 412. The spiral groove portion 410 is supported in a state where an outer peripheral end thereof is fitted/inserted between the stator disc spacer 128c on the lowermost stage and a base portion 141a of a partition portion 141.

In the third example, since the spiral groove portion 410 is provided on the rear surface side of the rotor disc 107c on the lowermost stage, by means of a mutual action of the rotor disc 107c on the lowermost stage and the spiral groove portion 410 in which the spiral groove is provided, a dominant directivity is given to the transferred gas molecules toward the outlet port 134. That is, the spiral groove portion 410 functions as the rectifying portion which rectifies the exhaust gas and also improves the exhaust performance of the exhaust gas in combination with the exhaust action. As a result, the exhaust performance of the vacuum pump 400 is improved, and since the non-contact seal structure is provided, flow-in of the exhaust gas into the accommodating portion 122 can be sufficiently prevented.

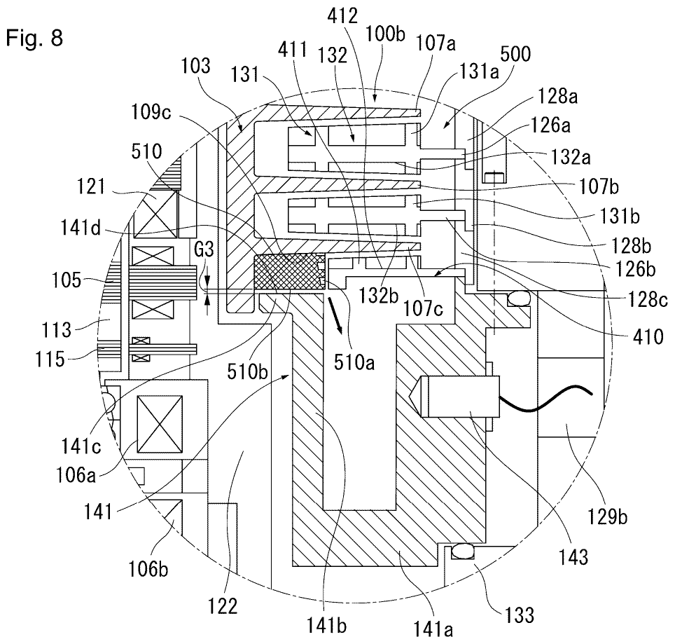

A vacuum pump according to a fourth example will be explained with reference to FIG. 8. Note that, in the fourth example, the same reference numerals are given to constituent elements similar to those in the vacuum pump in the third example, whose explanation will be basically omitted, and points different from those in the third example will be explained. The vacuum pump 500 according to the fourth example has a cylinder portion 510 as shown in FIG. 8. The cylinder portion 510 is fitted with the rotor 103 and is integrally fixed to the lower part of the rotor disc 107c on the lowermost stage, and is integrally constituted with the rotor disc 107c on the lowermost stage and the cylinder portion 510. The cylinder portion 510 rotates with the rotor disc 107c and the rotor 103. In an outer peripheral surface of the cylinder portion 510, a thread groove (spiral groove) 510a is formed, and the outer peripheral surface of the cylinder portion 510 in which this thread groove 510a is formed is opposed to inner/outer peripheral surfaces of the spiral groove portion 410. The thread-groove pump portion is constituted by the cylinder portion 510 in which the thread groove 510a is formed in the outer peripheral surface and the spiral groove portion 410.

A lower side surface 510b, which is a surface on the downstream side of the gas of the cylinder portion 510, and the upper surface 141d of the inward flange portion 141c are opposed to each other in the axial direction. This opposed surface constitutes the non-contact seal structure which prevents flow-in of the gas into the accommodating portion 122. Note that, this opposed surface extends over the periphery, and that the opposed surface is provided so that at least a part thereof constitutes the non-contact seal structure. A gap G3 to the lower side surface 510b of the cylinder portion 510 and the upper surface 141d to the inward flange portion 141c is assumed to be a micro gap. Note that the lower side surface 510b of the cylinder portion 510 and the upper surface 141d to the inward flange portion 141c are formed not as inclined surfaces but as horizontal surfaces.

In the fourth example, by means of rotation of the cylinder portion 510 in which a thread groove 510a is formed with the rotor 103, the exhaust gas is guided to the thread groove 510a and is transferred toward the outlet port 134 and thus, in combination with the effect of rectification of the exhaust gas by the spiral groove portion 410 to which the thread groove 510a is opposed on the outer peripheral surface and the exhaust action, the exhaust performance of the exhaust gas can be improved. As a result, the exhaust performance of the vacuum pump 500 is further improved, and since the non-contact seal structure by the lower side surface 510b of the cylinder portion 510 and the upper surface 141d to the inward flange portion 141c is provided, the flow-in of the exhaust gas into the accommodating portion 122 can be sufficiently prevented.

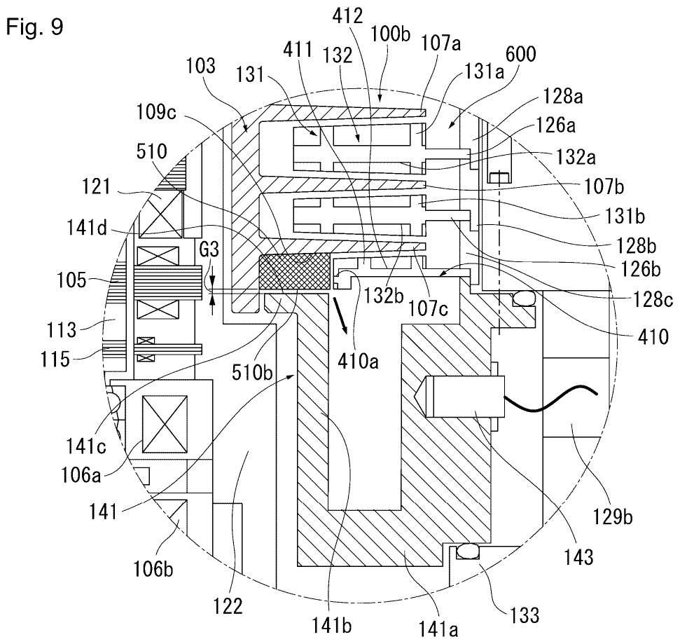

A vacuum pump according to a fifth example will be explained with reference to FIG. 9. Note that, in the fifth example, the same reference numerals are given to constituent elements similar to those in the vacuum pump according to the fourth example, whose explanation will be basically omitted, and points different from those in the fourth example will be Explained. In the vacuum pump 600 according to the fifth example, as shown in FIG. 9, a thread groove (spiral groove) 410a is formed not in the outer peripheral surface of the cylinder portion 510 but in the inner peripheral surface of the spiral groove portion 410 opposed to the outer peripheral surface of the cylinder portion 510. A thread-groove pump portion is constituted by the cylinder portion 510 and the spiral groove portion 410 in which the thread groove 410a is formed in the inner peripheral surface.

In the fifth example, by means of rotation of the cylinder portion 510 with the rotor 103, the exhaust gas is guided to the thread groove 510a formed in the inner peripheral surface of the spiral groove portion 410 and is transferred toward the outlet port 134 and thus, in combination with the effect of rectification of the exhaust gas by the spiral groove portion 410 and the exhaust action, the exhaust performance of the exhaust gas can be improved. As a result, the exhaust performance of the vacuum pump 600 is further improved, and since the non-contact seal structure by the lower side surface 510b of the cylinder portion 510 and the upper surface 141d to the inward flange portion 141c is provided, the flow-in of the exhaust gas into the accommodating portion 122 can be sufficiently prevented.

The present disclosure has been described by citing example as above, but the present disclosure is not limited to each of the aforementioned examples, but various variations and combinations can be made other than the aforementioned variations. For example, the example of the complex-type vacuum pump including the turbo-molecular pump portion 100a and the Siegbahn-type pump portion 100b is described in the aforementioned first example, and the example of the vacuum pump constituted by the turbo-molecular pump portion 100a in the aforementioned second example, but in the vacuum pump by the Siegbahn-type pump portion 100b, for example, the non-contact seal structure can be also constituted by using the rotor disc on the lowest stage, or the non-contact seal structure can be also constituted by newly providing the rotor disc portion not directly involved in the exhaustion of the exhaust gas.

Moreover, in the aforementioned first, and third to fifth examples, the example in which the rotor disc 107 (107a, 107b, 107c) is formed in the tapered state in which the section in the radial direction becomes thinner toward the peripheral edge part is described, but it does not necessarily have to be formed in the tapered state, but both surfaces on the upstream side and the downstream side may be formed as horizontal surfaces, for example.

Furthermore, in the aforementioned first, and third to fifth examples, the example in which the partition portion 141 is integral with the heater spacer is described, but the partition portion 141 may be a component separate from the heater spacer.

Moreover, in the aforementioned first, and third to fifth examples, the example in which the lower side surface 109c of the rotor disc 107c and the upper surface 141d of the inward flange portion 141c are both formed as the inclined surfaces is described, but the present disclosure can be applied even if either one of the surfaces is formed as the inclined surface.

Moreover, in the aforementioned second example, the example in which the lower side surface 201a of the rotor disc portion 201 and the upper surface 241a of the standing portion 241 are horizontal surfaces was explained, and in the aforementioned fourth and fifth examples, the examples in which the lower side surface 510b of the cylinder portion 510 and the upper surface 141d to the inward flange portion 141c are horizontal surfaces were explained, but these surfaces may be formed on an inclined surface whose inclination directions are the same, and inclination angles are substantially the same.

Moreover, in the aforementioned fourth example, the example in which the thread groove 510a is provided on the outer peripheral surface of the cylinder portion 510 is provided was explained, and in the aforementioned fifth example, the example in which the thread groove 410a is provided on the inner peripheral surface of the spiral groove portion 410 was explained, but the thread-groove pump portion may be constituted by providing both the thread groove 510a and the thread groove 410a.

Moreover, in the aforementioned second example, the spiral groove portion 410 in the aforementioned third example may be provided on the rear surface side, which is on the downstream side of the gas of the rotor disc portion 201. Moreover, in the aforementioned second example, it may be so configured that the cylinder portion 510 in the aforementioned fourth example is further fitted with the rotor 203 and is provided by being integrally fixed to the lower part of the rotor disc portion 201.

Moreover, in the aforementioned fourth and fifth examples, the cylinder portion 510 may be formed integrally with the rotor disc 107c on the lowermost stage and the rotor 103.

1. A vacuum pump comprising:
a casing;
a rotating shaft enclosed in the casing and rotatably supported;
an accommodating portion accommodating an electric component portion making the rotating shaft rotatable;
a rotor disposed on an outer side of the accommodating portion and constituted integrally with the rotating shaft;
a stator disposed on an outer peripheral side of the rotor;
a rotor disc portion extended in a radial direction from an outer peripheral surface of the rotor; and
an exhausted gas being flowing on an outside of the rotor by rotation of the rotor, wherein:
at least a part of opposed surfaces, opposed in an axial direction of the rotor disc portion and the stator, constitutes a non-contact seal structure which prevents flow-in of the gas into the accommodating portion.

2. The vacuum pump according to claim 1, wherein:
at least one of the opposed surfaces of the rotor disc portion and the stator is formed as an inclined surface.

3. The vacuum pump according to claim 2, wherein:
the opposed surfaces of the rotor disc portion and the stator are formed as inclined surfaces, and inclination angles of the inclined surfaces are the same.

4. The vacuum pump according to claim 1, wherein;
the stator further includes a stator disc portion opposed to an upstream side of the gas of the rotor disc portion in the axial direction;
a first spiral groove for constituting an exhaust mechanism is provided on at least one of opposed surfaces of the rotor disc portion and the stator disc portion; and
the non-contact seal structure is constituted by opposed surfaces, which are opposed in an axial direction, of a rear surface, which is a downstream side of the gas of the rotor disc portion, and the stator.

5. The vacuum pump according to claim 4, wherein the rotor disc portion constitutes a lowest stage of the exhaust mechanism.

6. The vacuum pump according to claim 5, further comprising:
a rectifying portion having an opposed surface opposed, in an axial direction, to a rear surface, which is a downstream side of the gas of the rotor disc portion.

7. The vacuum pump according to claim 6, wherein:
the rectifying portion is a spiral groove portion, which has a disc shape and has a second spiral groove provided on an opposed surface to the rotor disc portion.

8. The vacuum pump according to claim 7, wherein;
a cylinder portion constituted integrally with the rotor disc portion and having an outer peripheral surface opposed to an inner peripheral surface of the spiral groove portion is provided;
a thread groove provided on at least one of the inner peripheral surface of the spiral groove portion and the outer peripheral surface of the cylinder portion is provided; and
the non-contact seal structure is constituted by opposed surfaces, which are opposed in the axial direction, of a surface, which is a downstream side of the gas of the cylinder portion, and the stator.

9. The vacuum pump according to claim 1, wherein;
the stator includes a channel defining portion which is heated by a heating means and defines a channel of the gas; and
the non-contact seal structure is constituted by the opposed surfaces of the rotor disc portion and the channel defining portion opposed in the axial direction.
